(19) United States
(12) Patent Application Publication
(10) Pub. No.: US 2010/0146000 A1
(43) Pub. Date: Jun. 10, 2010

(54) Administering Blade Servers In A Blade Center

(75) Inventors: Raymond T. Greggs, Raleigh, NC (US); Alvaro Navas, Morrisville, NC (US); Noah O. Ogecha, Chapel Hill, NC (US); George T. Rochelle, Durham, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/327,877

(22) Filed: Dec. 4, 2008

(51) Int. Cl. G06F 17/30; G06F 7/00

(52) U.S. Cl. 707/792; 707/E17.01

(57) ABSTRACT

Administering blade servers in a blade center, where the blade center includes a plurality of blade servers; a blade management module operatively coupled to the blade servers, the blade management module also coupled for data communications to a remote management terminal; a media tray, the media tray comprising storage media available to the blade servers, the storage media including a universal serial bus (‘USB’) mass storage device; including storing in the USB mass storage device by the remote management terminal a data file; and providing by the blade management module to the blade servers access to the data file on the USB mass storage device.

### BACKGROUND OF THE INVENTION

1. Field of the Invention

The field of the invention is data processing, or, more specifically, methods, apparatus, and products for administering blade servers in a blade center.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas in which progress has been made is in the administration of numbers of blade servers in blade centers. A typical blade center may include a dozen or so blade servers or other types of computers in the blade form factor, while a data center taken as a whole may include hundreds or thousands of blade servers. Remotely moving files among blade servers can be a difficult task; a user or system administrator may need to install a single data file, for example, on all the blades in a same chassis, or, for that matter, on all or many of the blades in a same data center. One way to do this now is by sending the desired file by email and opening the email on each of the blades and download the file. Another alternative approach is to have the user telnet, log on remotely, from one blade to another and copy the desired file. Such a procedure, however, quickly become complex, requiring logons across firewalls and across different operating systems; also some users might not even know how to operate the telnet service. If the user is standing next to a blade center chassis, then moving files across blades in a single blade center can be done fairly easily by inserting a USB key or any other media device in the USB ports of the chassis, that is, for example, through a media tray. If, however, the user is located remotely from the blade center or centers, or if a file needs to be applied to hundreds or thousands of blades, the task can be long and exhausting.

### SUMMARY OF THE INVENTION

Methods, apparatus, and computer program products are disclosed for administering blade servers in a blade center, where the blade center includes a plurality of blade servers; a blade management module operatively coupled to the blade servers, the blade management module also coupled for data communications to a remote management terminal; a media tray, the media tray comprising storage media available to the blade servers, the storage media including a universal serial bus (‘USB’) mass storage device; including storing in the USB mass storage device by the remote management terminal a data file; and providing by the blade management module to the blade servers access to the data file on the USB mass storage device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a diagram of an example data processing system capable of administering blade servers in a blade center according to embodiments of the present invention.

FIG. 2 sets forth a diagram of a further example data processing system capable of administering blade servers in a blade center according to embodiments of the present invention.

FIG. 3 sets forth a flow chart illustrating an example method of administering blade servers in a blade center according to embodiments of the present invention.

### DETAILED DESCRIPTION OF EXEMPLARY EMBODIMENTS

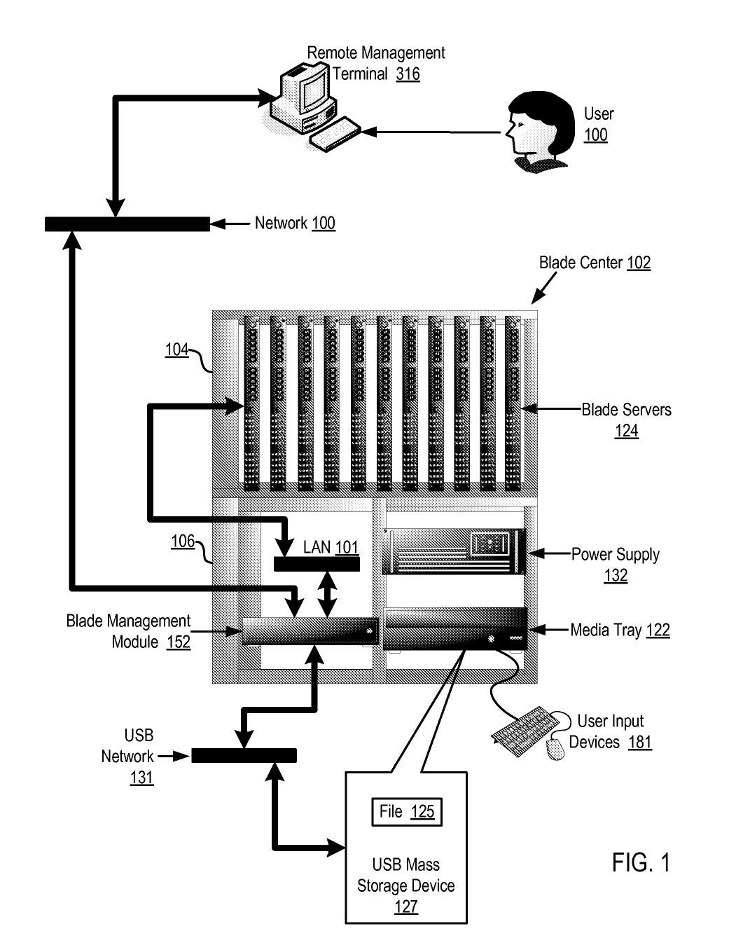

Exemplary methods, apparatus, and products for administering blade servers in a blade center in accordance with the present invention are described with reference to the accompanying drawings, beginning with FIG. 1. FIG. 1 sets forth a diagram of an example data processing system capable of administering blade servers in a blade center according to embodiments of the present invention. The data processing system of FIG. 1 includes a blade center (102) that is coupled for data communications through a network (100) to a remote management terminal (104). ‘Blade center,’ as the term is used in this specification, refers generally to a blade server system installed in this example in a two-bay chassis (104, 106) and including a number of blade servers (124), one or more blade management modules (152), a media tray (122), and a blade server system power supply (132).

The blade management module (152) is a small computer in its own right, including software and hardware components, one or more computer processors and computer memory, that provides system management functions for all components in the example blade center (102) including the blade servers (124) and the media tray (122). The blade servers themselves (124), installed in cabinet bay (104) of the exemplary blade center (102) in the example of FIG. 1, are several computing devices implemented in blade form factor. The blade servers share access to the media tray (122). The blade servers (124) are connected to one another and to the blade management module (152) for data communications through a local area network (‘LAN’) (101). The LAN (101) is a small network installed within the chassis of the blade center.

The media tray (122) houses non-volatile memory media generally and also makes available connections for user input devices such as mice or keyboards (181) that are not generally connected directly to the blade servers or to the blade center chassis. A media tray may typically include Compact Disc read-only media drives (‘CD-ROM’), Digital Video Disc ROM drives (DVD-ROM), CD-RW drives, DVD-RW drives, floppy disk drives, and so on as will occur those of skill in the art. The example media tray (122) in the system of FIG. 1 includes a Universal Serial Bus (‘USB’) mass storage device (127), such as a USB CD-ROM drive or EEPROM drive, that is connected for data communication through a USB network (131) to the blade management module (152). The example data processing system of FIG. 1 operates generally to administer blade servers in a blade center by a user's operating the remote management terminal to store a file (125) in the USB mass storage device (127). The blade management module (152) then provides the blade servers (124) access to the data file (125) on the USB mass storage device (127).

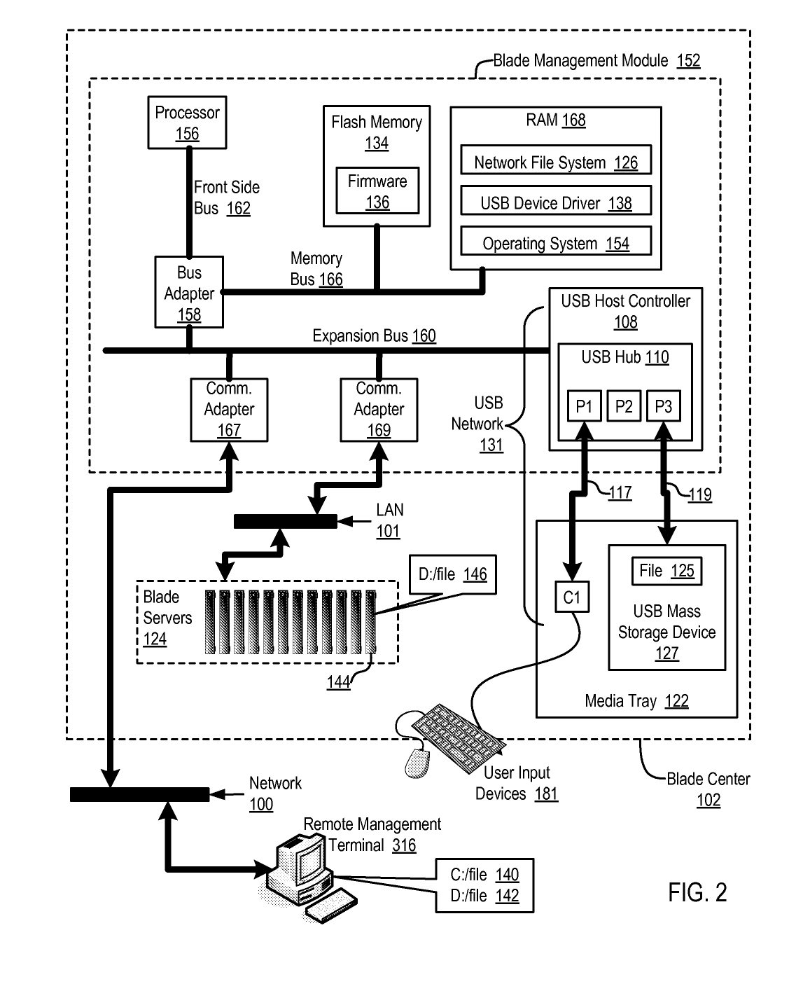

The arrangement of the blade center (192), the remote management terminal (316), the networks (100, 101, 131), and other devices making up the exemplary system illustrated in FIG. 1 are for explanation, not for limitation. Data processing systems useful according to various embodiments of the present invention for administering blade servers in a blade center may include additional servers, routers, and other devices, not shown in FIG. 2, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 2.

For further explanation, FIG. 2 sets forth a diagram of a further example data processing system capable of administering blade servers in a blade center according to embodiments of the present invention. The example data processing system of FIG. 2 is similar to the example of FIG. 1, including as it does a blade center (102) coupled for data communication through a network (100) to a remote management terminal (104), blade servers (124) connected through an internal LAN (101) to a blade management module (152), a media tray (122) connected to the blade management module through a USB network (131), and a USB mass storage device (127) in the media tray. The USB mass storage device (127) is installed in the media tray (122) so that the USB mass storage device is available to the blade servers (124) and to the remote management terminal (316) for data storage and retrieval. In addition, however, by contrast with FIG. 1, FIG. 2 also includes a functional block diagram showing more detail of the blade management module (152). The blade management module (152) of FIG. 1 includes at least one computer processor (156) or ‘CPU’ as well as random access memory (168) (‘RAM’) which is connected through a high speed memory bus (166) and bus adapter (158) to processor (156) and to other components of the blade management module (152).

In the example of FIG. 2, the USB network (131) is composed of a USB host controller (108), a USB hub (110), several USB ports (P1, P2, P3), USB bus connections (117, 119), and a USB connector (C1) in the media tray (122). The media tray (122) installed in the example blade center (102) of FIG. 2 is connected to the USB host controller (108) in the blade management module through a USB bus connection (119) and USB port (P3) in USB hub (110). The USB host controller (108) detects the presence of USB devices on the USB network, in this example, detecting the presence of user input devices (181) that are connected to the USB network through USB connector C1 in the media tray and also detecting the presence on the USB network of a USB mass storage device (127). Upon detecting the presence of the USB mass storage device (127), the USB host controller exposes the USB mass storage device to the operating system (154) of the blade management module (152) through USB device driver (138) as a local file system.

The USB architecture generally provides a serial bus standard for connecting together devices such as, for example, computers, game consoles, personal digital assistants, televisions, stereo equipment, and so on. The USB standard, which is jointly authored by Compaq, Hewlett-Packard, Intel, Lucent, Microsoft, NEC, and Philips, sets forth criteria for developing USB components and communicating among the components. USB components include, for example, devices, cables, hubs, hosts, ports, interfaces, mass storage devices, and so on. In USB terminology, the exemplary blade management module (152) containing the host controller (108) is referred to as a ‘host.’ The USB host controller (108) provides an interface for other components of the exemplary blade management module (152) to utilize USB hubs and USB devices connected to the USB host controller (108). The USB host controller (402) may be implemented as a combination of hardware, firmware, or software. The exemplary USB host controller (108) of FIG. 2 controls the USB hub (110). A USB hub is a device that allows many USB devices to be connected to a single USB port on a host computer or another hub. A hub (110) in a host controller (108) is generally referred to as a ‘root hub.’

A USB mass storage device is a device that implements the USB mass storage device class (‘USB MSC’). The USB MSC is set of computing communications protocols defined by the USB Implementers Forum that run on the Universal Serial Bus. The standard provides an interface to a variety of storage devices. Some of the devices that can be connected to computers via this standard include:
external magnetic hard drives;
external optical drives, including CD and DVD reader and writer drives;
portable flash memory devices, particularly keydrives;
adapters bridging between standard flash memory cards and a USB connection;
digital cameras;
digital audio players high-end hardware media players;
Card Readers;
Portable Gaming systems;
personal data assistants and handheld computers;
some newer mobile phones, such as the Sony Ericsson K800 and K510, Nokia N73, Nokia E61;
USB Keystroke loggers; and
others as will occur to those of skill in the art.

The example data processing system of FIG. 1 operates generally to administer blade servers in a blade center by a user's operating the remote management terminal to store a data file (125) in the USB mass storage device (127). In the example of FIG. 1, storing the data file in the USB mass storage device may be carried out, for example, by mapping the USB storage device onto the remote management terminal as a remote disk drive and copying the data file from local storage media on the remote management terminal to the mapped USB storage device. The blade management module (152) then provides the blade servers (124) access to the data file (125) on the USB mass storage device (127). In the example of FIG. 2, the blade management module (152) can provide the blade servers (124) access to the data file (125) on the USB mass storage device (127) by mapping the USB mass storage device to the one or more blade servers as a remote disk drive.

Stored in RAM in this example are a network file system (126) and a USB Device Driver (138). The network file system (126) is a computer file system, a module of software and computer hardware, that supports sharing of files and other resources as persistent storage among two or more computers over a data communications network. Network file systems that can be adapted for administration of blade servers in a blade center include, for example, a network file system from Sun Microsystems that is actually named Network File System and is often referred as ‘NFS’ as well as the Andrew File System (‘AFS’), the NetWare Core Protocol (‘NCP’), and the Server Message Block (‘SMB’) file system which is also known as Common Internet File System or ‘CIFS.’

The network file system (126) operates in this example to make the USB mass storage device (127), exposed to the network file system by the USB device driver (138) as a local file system of the blade management module (152), appear to the remote management terminal (104) and to the blade servers (124) as a conventional local file system. The network file system (126) renders invisible the fact that the USB mass storage device is in fact a USB mass storage device mounted in the media tray of the blade management module rather than a local file system on the remote management terminal or a blade server. In operation of the network file system (126), software running on the remote management terminal (104) and software running on the blade servers (124) do not distinguish between local and remote file storage. From the perspective of the remote management terminal, the file (125) stored in the USB mass storage device appears to be a file stored on a local disk drive within the remote management terminal. From the perspective of a blade server, the file (125) stored in the USB mass storage device (127) appears to be a file stored on a local disk drive within the blade server.

It is the network file system (126) itself that locates the actual files under management and arranges for transport of data within the files. In an example, therefore, where the remote management terminal (104) has on its C: drive a file (140) to be stored in the USB mass storage device (127) and the USB mass storage device is mapped as a network drive to the remote management terminal through the USB device driver (138) and the network file system (126) as the D: drive on the remote management terminal, the remote management terminal stores the file on the USB mass storage device by moving or copying, in the perspective of the remote management terminal, the file from the C: drive on the remote management terminal to the D: drive (142) on the remote management terminal. In another similar example, where the USB mass storage device (127) has stored upon it a file (125) to be accessed by a blade servers (144) and the USB mass storage device is mapped as a network drive to the blade server through the USB device driver (138) and the network file system (126) as the D: drive on the blade server (144), the blade server (144) accesses the file (125) on the USB mass storage device (127) as a file (146) on a drive that appears, in the perspective of the blade server, as a file (146) on the blade server's local D: drive—even if the blade server in fact has no local disk drive whatsoever installed upon it.

Also stored in RAM (168) is an operating system (154). Operating systems useful for administering blade servers in a blade center according to embodiments of the present invention include UNIX™, Linux™, Microsoft Windows XP™, Microsoft Vista™, AIX™, IBM's i5/OS™, and others as will occur to those of skill in the art. The operating system (154), the network file system (126), and the USB device driver (138) in the example of FIG. 2 are shown in RAM (168), but many components of such software typically are stored in non-volatile memory also, such as, for example, on a disk drive or in firmware (136) on an EEPROM drive, here shown as flash memory (134).

The exemplary blade management module (152) of FIG. 2 includes a communications adapter (167) that couples the blade management module (152) for data communications with the remote management terminal (104) through a local area data communications network (100). The exemplary blade management module (152) of FIG. 2 also includes a communications adapter (169) that couples the blade management module (152) internally within the blade center (102) for data communications with blade servers (124) through a local area network (101). Both networks (100, 101) may be implemented, for example, as an Internet Protocol (‘IP’) network or an Ethernet™ network, an I²C network, a System Management Bus (‘SMBus’), an Intelligent Platform Management Bus (‘IPMB’), for example, and in other ways as will occur to those of skill in the art. Such communications adapters (167, 168) are electronic modules that implement the hardware level of data communications through which one computer sends data communications to another computer through a data communications network. Examples of communications adapters useful for controlling shared access of a media tray according to embodiments of the present invention include modems for wired dial-up communications, Ethernet (IEEE 802.3) adapters for wired data communications network communications, and 802.11 adapters for wireless data communications network communications.

The arrangement of the blade management module (152), the blade servers (124), the remote management terminal (316), the networks (100, 101, 131), and other devices making up the exemplary system illustrated in FIG. 2 are for explanation, not for limitation. Data processing systems useful according to various embodiments of the present invention for administering blade server in a blade center may include additional servers, routers, and other devices, not shown in FIG. 2, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 2.

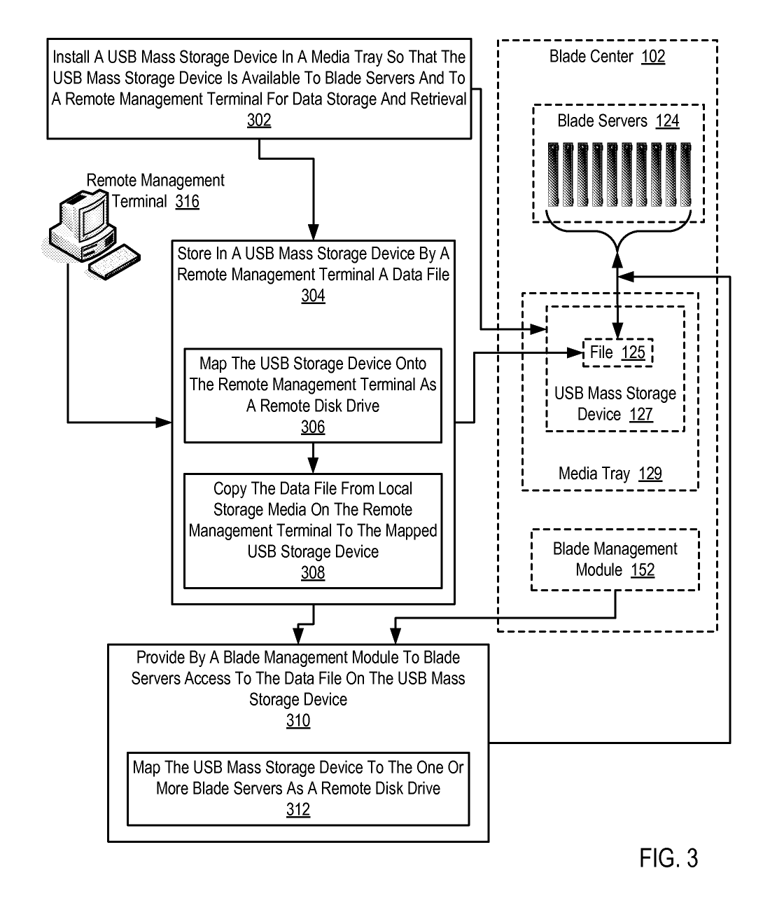

For further explanation, FIG. 3 sets forth a flow chart illustrating an example method of administering blade servers in a blade center according to embodiments of the present invention. For ease of explanation, the example of FIG. 3 is explained with reference not only to FIG. 3 itself, but also with reference to FIGS. 1 and 2. The example method of FIG. 3 is carried out in a data processing system similar to those illustrated and described above in this specification with regard to FIGS. 1 and 3. That is, the example method of FIG. 3 is carried out in a blade center (102) that includes a number of blade servers (124), that is, computing devices having the industry-standard blade form factor. The blade center also includes a blade management module (152) that is operatively coupled to the blade servers through, for example, a data communications network (101). The blade management module (152) is also coupled for data communications to a remote management terminal through, for example, a data communications network (100). The blade center includes a media tray, where the media tray provides a facility through which storage media may be made available to the blade servers.

The example method of FIG. 3 includes installing (302) a USB mass storage device (127) in the media tray (127) so that the USB mass storage device (127) is available to the blade servers (124) and to the remote management terminal (316) for data storage and retrieval. The USB mass storage device may be made available to the blade servers by connecting the USB mass storage device (127) to the blade management module (152) through a USB port P3 in a USB hub (110) in a USB host controller (108) in the blade management module.

The example method of FIG. 3 includes remote management terminal's (316) storing (304) a data file (125) in the USB mass storage device (127). In this example, storing (304) the data file (125) includes mapping (312) the USB storage device (127) onto the remote management terminal (316) as a remote disk drive and copying (308) the data file from local storage media on the remote management terminal to the mapped USB storage device. Mapping (312) the USB storage device onto the remote management terminal as a remote disk drive can be carried out, for example, by exposing the USB storage device (127) to the remote management terminal (316) through a USB device driver (138) and a network file system (126) as a file system (142) that appears local to the remote management terminal (316). Copying (308) the data file from local storage media on the remote management terminal to the mapped USB storage device, then, can be carried out by copying or moving the file from an actual local disk drive (140) on the remote management terminal to the mapped file system (142) that appears local to the remote management terminal but in fact is storage in the USB mass storage device (127) in the media tray of the blade center (102)—with the transfer of the file (125) from the remote management terminal (316) to the USB mass storage device (127) carried out by the network file system (126), the USB device driver (138), and the USB host controller (108) in a manner that is transparent from the perspective of the remote management terminal (316).

The method of FIG. 3 also includes providing (310) by the blade management module (152) to the blade servers (124) access to the data file (125) on the USB mass storage device (127). In the method of FIG. 3, providing (310) access to the data file (125) includes mapping (312) the USB mass storage device (127) to the one or more blade servers (124) as a remote disk drive. Mapping (312) the USB mass storage device to the one or more blade servers as a remote disk drive can be carried out, for example, by exposing the USB storage device (127) to the blade servers (124) through a USB device driver (138) and a network file system (126) as a file system (146) that appears local to the blade servers (124). The blade server then can access the file (125) on the USB mass storage device (127) as a file (146) on a drive that appears, in the perspective of the blade server, as a file (146) on the blade server's local drive—even if the blade server in fact has no local disk drive whatsoever installed upon it.

Exemplary embodiments of the present invention are described largely in the context of a fully functional computer system for administering blade servers in a blade center. Readers of skill in the art will recognize, however, that the present invention also may be embodied in a computer program product disposed on computer readable signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of administering blade servers in a blade center, the blade center comprising:
a plurality of blade servers;
a blade management module operatively coupled to the blade servers, the blade management module also coupled for data communications to a remote management terminal;
a media tray, the media tray comprising storage media available to the blade servers, the storage media including a universal serial bus (‘USB’) mass storage device;
the method comprising:
storing in the USB mass storage device by the remote management terminal a data file; and
providing by the blade management module to the blade servers access to the data file on the USB mass storage device.

2. The method of claim 1 wherein storing in the USB mass storage device by the remote management terminal a data file further comprises:
mapping the USB storage device onto the remote management terminal as a remote disk drive; and
copying the data file from local storage media on the remote management terminal to the mapped USB storage device.

3. The method of claim 1 wherein providing by the blade management module to one or more of the blade servers access to the data file on the USB mass storage device further comprises mapping the USB mass storage device to the one or more blade servers as a remote disk drive.

4. The method of claim 1 further comprising installing the USB mass storage device in the media tray so that the USB mass storage device is available to the blade servers and to the remote management terminal for data storage and retrieval.

5. The method of claim 1 wherein a blade management module operatively coupled to the blade servers further comprises a blade management module operatively coupled to the blade servers through a data communications network.

6. The method of claim 1 wherein the blade management module also coupled for data communications to a remote management terminal further comprises the blade management module also coupled for data communications to a remote management terminal through a data communications network.

7. Apparatus for administering blade servers in a blade center, the blade center comprising a plurality of blade servers; a blade management module operatively coupled to the blade servers, the blade management module also coupled for data communications to a remote management terminal; and a media tray, the media tray comprising storage media available to the blade servers, the storage media including a universal serial bus (‘USB’) mass storage device;
the apparatus comprising a computer processor, a computer memory operatively coupled to the computer processor, the computer memory having disposed within it computer program instructions capable of:
storing in the USB mass storage device by the remote management terminal a data file; and
providing by the blade management module to the blade servers access to the data file on the USB mass storage device.

8. The apparatus of claim 7 wherein storing in the USB mass storage device by the remote management terminal a data file further comprises:
mapping the USB storage device onto the remote management terminal as a remote disk drive; and
copying the data file from local storage media on the remote management terminal to the mapped USB storage device.

9. The apparatus of claim 7 wherein providing by the blade management module to one or more of the blade servers access to the data file on the USB mass storage device further comprises mapping the USB mass storage device to the one or more blade servers as a remote disk drive.

10. The apparatus of claim 7 wherein a blade management module operatively coupled to the blade servers further comprises a blade management module operatively coupled to the blade servers through a data communications network.

11. The apparatus of claim 7 wherein the blade management module also coupled for data communications to a remote management terminal further comprises the blade management module also coupled for data communications to a remote management terminal through a data communications network.

12. A computer program product for administering blade servers in a blade center, the blade center comprising a plurality of blade servers; a blade management module operatively coupled to the blade servers, the blade management module also coupled for data communications to a remote management terminal; a media tray, the media tray comprising storage media available to the blade servers, the storage media including a universal serial bus (‘USB’) mass storage device;
wherein the computer program product is disposed in a signal bearing medium, the computer program product comprising computer program instructions capable of:
storing in the USB mass storage device by the remote management terminal a data file; and
providing by the blade management module to the blade servers access to the data file on the USB mass storage device.

13. The computer program product of claim 12 wherein the signal bearing medium comprises a recordable medium.

14. The computer program product of claim 12 wherein the signal bearing medium comprises a transmission medium.

15. The computer program product of claim 12 wherein storing in the USB mass storage device by the remote management terminal a data file further comprises:
mapping the USB storage device onto the remote management terminal as a remote disk drive; and
copying the data file from local storage media on the remote management terminal to the mapped USB storage device.

16. The computer program product of claim 12 wherein providing by the blade management module to one or more of the blade servers access to the data file on the USB mass storage device further comprises mapping the USB mass storage device to the one or more blade servers as a remote disk drive.

17. The computer program product of claim 12 wherein a blade management module operatively coupled to the blade servers further comprises a blade management module operatively coupled to the blade servers through a data communications network.

18. The computer program product of claim 12 wherein the blade management module also coupled for data communications to a remote management terminal further comprises the blade management module also coupled for data communications to a remote management terminal through a data communications network.
